(19) United States
(12) Patent Application Publication
(10) Pub. No.: US 2015/0316157 A1
(43) Pub. Date: Nov. 5, 2015

(54) SHUT-OFF MEMBER WITH RINSING

(71) Applicant: AUROTEC GMBH, Regau (AT)

(72) Inventors: Stefan Zikeli, Regau (AT); Michael Longin, Seewalchen am Attersee (AT); Friedrich Ecker, Timelkam (AT); Klaus Weidinger, Lenzing (AT)

(73) Assignee: AUROTEC GMBH, Regau (AT)

(21) Appl. No.: 14/650,166

(22) PCT Filed: Dec. 13, 2013
(86) PCT No.: PCT/EP2013/076589

§ 371 Date: Jun. 5, 2015

(30) Foreign Application Priority Data
Dec. 14, 2012 (EP) 12197179.0

(51) Int. Cl. F16K 5/06; B29C 47/00; B29C 47/08; F16K 27/06

(52) U.S. Cl. CPC F16K 5/0605; F16K 27/067; B29C 47/0004; B29C 47/0813; B29L 2031/772

(57) ABSTRACT

A shut-off member is provided having a valve housing with an interior and with at least one inlet and at least one outlet, and a closure element which is mounted in the interior so as to be rotatable about an axis, wherein a free space for through-flow of a fluid between inlet and outlet is present between the closure element and the valve housing, and a pair of sealing surfaces is provided on the at least one inlet between valve housing and closure element, and wherein the sealing surface of the closure element is pivotable by rotation of the closure element and, in the locked position of the shut-off member, blocks the inlet by bearing in a fluid-tight manner on the sealing surface of the valve housing, wherein a gap or free space is provided around the closure element.

The present invention relates to a shut-off member for pipelines for the transport of chemically unstable fluids, in particular highly viscous fluids at high pressure.

The prior art already contains a plurality of most diverse shut-off members which are primarily adapted to achieve a reliable seal in the closed state and at the same time to achieve easy operation. In most cases, this is accomplished by eccentric mounting and/or eccentric design of the closure element.

For example, U.S. Pat. No. 3,552,434 A discloses a plug valve having a pressing link which presses the closure element in the closed state against the seal. As a result of an outlet-side transverse opening which, in the closed state or at low throughput volume, prevents a rinsing flow in certain areas, and as a result of the small gap cross-section in the open position, this apparatus is unsuitable for highly viscous or polymeric, thermally unstable fluids.

U.S. Pat. No. 3,314,645 A also discloses a plug valve where the plug is provided with an eccentrically disposed opening. However, as a result of the dead spaces formed at the base and cover and the unfavourable arrangement of the through hole, this geometry of a plug valve also has a disadvantageous effect on flows so that in the case of highly viscous media, accumulations or depositions of fluid occur in the resulting “dead zones”. This applies in particular to partial opening of the plug valve in which flow only takes place through parts of the free space.

FR 1 142 546 A discloses a valve having an eccentrically mounted asymmetric closure element around which flow takes place in the open position. In this case, the sealing force must be applied to the sealing surfaces via the eccentric mounting and a permanent torque. Particularly in the case of high-pressure fittings, this leads to difficulties due to the high forces and viscosities. In addition, this disadvantageously comprises a very complex and therefore expensive design of the closure element.

GB 2 376 056 A discloses a central heating shut-off valve with a closure element around which flow takes place externally. As a result of the position and shape of the closure element and in part the small or vanishing gap cross-sections, however, no uniform rinsing free from dead spaces can be achieved.

U.S. Pat. No. 2,803,426 A describes a plug valve for solid-containing media, where the sealing effect is achieved by an eccentrically sealing closure element. As a result of the unfavourable flow conditions, non-rinsed dead spaces are unavoidable. As a result of the required closing functionality, an adapted gap course for reliable rinsing of the gaps is also not possible.

DE 11 27 853 B and U.S. Pat. No. 4,103,868 A attempt in various ways to achieve easy operation. DE 11 27 853 B discloses a rotary or transverse slider for high-pressure systems with a gap in the housing to compensate for high pressing forces in a shut-off position; however, a rinsing flow from the inlet through the gap to the outlet is not provided. U.S. Pat. No. 4,103,868 A attempts by means of a special form of closure element to minimise the hydraulic forces during opening and closing. However, this results in undefined flow conditions and dead zones in the region of the closure element.

In order to protect the sealing surfaces during the switching process, U.S. Pat. No. 4,542,878 A discloses a ball valve with an undercut surface, where in each case a pair of sealing surfaces is provided both at the inlet and at the outlet so that an inclusion of fluid comes about both in an open position and in a shut-off position.

In the documents listed so far, shut-off members are therefore disclosed in which, in most cases frequently as a side effect, gaps are formed between the closure element and a housing. However, these gaps are subordinate to the secured sealing so that dead spaces in the region of the gaps do not play any role and do not attract any attention. None of the documents is concerned with highly viscous and thermally unstable fluids so that a specific rinsing of the gaps free from dead spaces also does not seem expedient or even necessary. Consequently, none of the documents discloses a shut-off member for pipelines which would be suitable and designed for the transport of highly viscous and thermally unstable fluids.

In addition, a ball valve is known in which a blind hole is provided to counteract a pressure rise in a dead space in a sealing element so that in the event of an inadmissibly high pressure, the sealing surface gives way resiliently (DE 44 33 985 A1). This arrangement however has the disadvantage that pressure rises cannot be avoided in the dead space. In addition, this arrangement is reliant on a resilient sealing element which cannot be used in some applications, e.g. at high temperatures or with solvent-containing fluids.

The patent specification U.S. Pat. No. 6,267,353 describes a shut-off member in which large-area dead spaces are provided, with the intention that these can be rinsed more easily by fluid flowing past. Depending on the fluid, in particular with viscous fluids, this does not take place as desired and results in permanent deposits.

US 2008/0105845 A1 and US 2011/0309280 A1 describe ball valves whose spherical plugs are rinsed in the partially open position. In the fully open position (US 2008/0105845 A1) and in the closed position (both patents), however closed dead spaces are formed in which chemically unstable fluids decompose and could lead to explosion-like reactions as a result of an unrelievable pressure. These ball valves were therefore suggested principally for use with chemically stable fluids, e.g. for use in the foodstuffs industry. The scope for rinsing of the ball valves designed according to US 2008/0105845 A1 is restricted to operating states in the partially open position, such designs are therefore preferably only suitable for volume flow regulating purposes. Fittings formed in this manner are completely unsuitable as shut-off members since the closed dead spaces formed constitute appreciable safety risks.

Stress-relief holes in valves are described in the patent specifications U.S. Pat. No. 3,464,494 and EP 0 781 356 B1. However, such stress-relief holes to an outer region of the valve have the disadvantage of a fluid loss and require a complex pressure control of the stress-relief hole, particularly when a specific apparatus is to be used alternately for use at different pressures.

It is an object of the present invention to provide improved shut-off members adapted to the operating conditions which in particular are suitable for transporting chemically unstable fluids without hazardous decomposition products forming in dead spaces of the member. In this case, in particular a specific and as far as possible dead-space-free rinsing of the free space or gap between closure element and valve housing should be ensured, i.e. it is important to avoid regions of the free space free from rinsing flow or regions with negligible rinsing flow. In particular, any inclusion of fluid in the housing of the shut-off member should be prevented under all circumstances, i.e. preferably in each position of the closure element. Important operating conditions can, as explained further below according to the invention, be expressed by the gap speed, the free space—exchange area, by the rinsing flow ratio and the rinsing number. For the person skilled in the art it is clear however that the operating conditions according to the invention listed above must also be accompanied by further operating measures or system designs. Thus, thermally unstable fluids consisting of the composition cellulose/amine oxide/water are known which can react exothermally under specific process conditions. Factors which can cause and catalyse an exothermic reaction in the case of conveying a cellulose/amine oxide/water solution are, for example, increased production temperatures (>100° C.), a reduced water content, an increased fraction (base level) of transition metal ions (>10 ppm iron), an increased fraction of peroxides and the use of unsuitable materials (such as, for example, non-ferrous metals, unpassivated stainless steel, carbon steel) for the polymer transport system which can consist of pipelines, heat exchangers and transport pumps.

In addition to the aforesaid installation and process-technology operating conditions, the invention provides a shut-off member and a process executed with this shut-off member which, in order to avoid dead spaces in the open position, enables a rinsing of the internally mounted closure element or closure part adapted to the operating conditions, in particular for use in a pipeline for transport of a chemically or thermally unstable fluid. The invention is further defined in the claims.

The invention relates in particular to a shut-off member or shut-off valve which comprises a valve housing having an interior and at least one inlet and at least one outlet and a closure element, which is mounted rotatably about an axis in the interior, wherein between the closure element and the valve housing there is a free space for flow of a fluid between inlet and outlet and a pair of sealing surfaces is provided at the at least one inlet between valve housing and closure element, wherein the sealing surface (seal) of the closure element is pivotable through rotation of the closure element and in the locking position of the shut-off member shuts off the inlet by fluid-tight bearing against the sealing surface of the valve housing, characterised in that the distance of the sealing surfaces from the axis or the centre point of the sphere is greater than the distance of the axis or the centre point of the sphere to other outer regions of the closure element in order to form the free space which in the locking position is connected to the outlet in a fluid-conducting manner and/or that the distance of the sealing surfaces from the axis or the centre point of the sphere is shorter than the distance of the axis or the centre point of the sphere to other regions of the valve housing interior in order to form the free space which in the locking position is connected to the outlet in a fluid-conducting manner. The shut-off member can be used in bilateral orientation, either from the inlet to the outlet or from the outlet to the inlet. The designations inlet and outlet are used herein to distinguish openings.

The shut-off member according to the invention enables a secure closure of a line to interrupt a fluid flow between the inlet and the outlet. In this case, the invention is not limited to shut-off members having one inlet and one outlet but in addition to this embodiment, can also have a plurality of inlets and/or outlets. In this form, the shut-off member according to the invention can be used as a distributor piece or combining piece or as a changeover switch between different inlets and outlets. In specific embodiments the shut-off member according to the invention has one, two, three or more inlets.

For the closure, a closure element is provided in the interior space of the shut-off member which is provided rotatably about an axis and upon rotation into a locking position blocks the inlet, the plurality of inlets or all the inlets. Usually the outlet remains unblocked—both in the locking and in the open position, so that fluid can emerge from the shut-off member at any time. This emergence is in particular made possible by means of the free space which has a flow communication to the outlet. Preferably the free space is connected to the outlet in each rotation position of the locking element so that fluid can emerge from the free space at any time.

The free space enables rinsing of the closure element. It can be formed by recesses or milled recesses in the housing or in the closure element. The closure element—also designated as closing part or plug—can have one or more holes or slots for passage of fluid between inlet and outlet or it can be free from holes. In the open position or partially open position of the shut-off member, the inlet and the outlet can be connected via free space and through holes or however only via the free space in a fluid conducting manner.

Apart from these alternative embodiments with or without through hole, all other features and embodiments described herein can be combined with one another in arbitrary form.

A problem of previous closure elements is the formation of dead spaces which are not adequately rinsed or which in certain rotation positions form closed spaces. According to the invention these disadvantages are avoided so that a draining of fluid from dead spaces is always possible or the dead spaces are completely avoided since a substantial fluid flow is guided via the free space as otherwise potential dead space. In this case, the cross-section of the free space between the valve housing and the closure element in a partial and/or complete open position of the shut-off member can preferably be matched to the viscosity of the fluid and be at least sufficiently large that in the free space on both sides of the axis, in particular simultaneously, a rinsing flow is achieved.

The guidance of fluid via the free space is accomplished in a partial and complete open position but can also be accomplished exclusively in a partially open position (in particular in embodiments with closure elements in which the distance of the sealing surface from the axis or centre point of the sphere is greater than the distance of the axis or centre point of the sphere from other outer surfaces of the closure element). In connection with such a rinsing in a partially open position it is favourable if the closure element is adapted for periodic or cyclic rinsing of the free space behind the pair of sealing surfaces.

Both the housing, in particular around the inlet, and also the closure element have a sealing surface, which are jointly designated as pair of sealing surfaces. As a result of the abutment of both sealing surfaces, the inlet is blocked by the closure element in a fluid non-conducting manner. Depending on the shape of the valve housing, the sealing surfaces can have different geometries. The sealing surfaces around the inlet can be polygonal, rectangular, round, in particular circular or oval, in view. The closure element can be partially cylindrical or partially spherical.

According to the invention distances from the axis or the centre point of the sphere are specified in order to describe specific free spaces which serve as an optionally alternative flow region. The reference “axis” or “centre point of sphere” depending on the shape of the closure element thus relates to the centre point which is positioned centrally from the rotationally symmetrical closure element. In the case of cylindrical closure elements this is an axis. In the case of spherically symmetrical closure elements, this is the centre point of the sphere. That is, it is generally advantageous if the axis of the closure element is disposed at the centre point of the closure element. Naturally various other rotationally symmetrical shapes are also included herewith such as, for example oval shapes. The terms “axis” or “centre point of sphere” should therefore not be understood as being restricted to a specific shape. Unless not explicitly excluded, when using the term “axis” or “centre point of sphere” other shapes should always be included. In sectional views this centre point is usually designated for simplicity as “axis”. Distance from the axis always relate here to a surface section normal to the axis in a specific axial position (e.g. distance from centre point of sphere on the axis). According to these sections, the concepts of a distance from the axis (2D in section) and from the centre point of a sphere (3D) are equivalent regardless of the shaped body to which the closure element corresponds.

In a partially spherical configuration, the shut-off member according to the invention is also designated as ball valve. The closure element can additionally or alternatively comprise a spherical segment-shaped shut-off part having the sealing surface. Such a shut-off part can be a projection which is positioned for fluid-tight shut-off in the locking position before the inlet by rotation of the shut-off element. At other places of the shut-off element, a recess can be provided compared to this projection, whereby the free space is formed. Consequently, the distance of the sealing surfaces from the axis or centre point of the sphere is greater than the distance of the axis or centre point of the sphere from other outer regions of the closure element in order to form the free space which in the locking position is connected to the outlet in a fluid-conducting manner. This configuration is particularly preferred in embodiments with a closure element without the above-mentioned flow hole.

Regions according to the invention having a distance from the axis which is shorter than the distance of the sealing surfaces from the axis in order to form the free space which is connected to the outlet in the locking position in a fluid-conducting manner can also be formed in the presence of a through hole through the closure element. In this configuration, a recess is preferably provided in the housing towards the interior space whereby fluid can be guided around the closure element. In a partially open position fluid flow is thereby made possible from the inlet through the through hole further via the recess towards the outlet. Another path of the fluid through the shut-off member according to the invention is through the region having the shorter distance from the axis or centre point of the sphere (e.g. the part of the hemispherical closure element remote from the through hole) via the recess in the housing to the outlet. In a particularly preferred embodiment the shut-off part of the shut-off element, which part is delimited by the sealing surface, also contains a recess. As a result, a flow from the inlet via the recess in the shut-off part, further via the recess in the housing part to the outlet is made possible. According to this embodiment, all the free spaces around the shut-off element are rinsed by the fluid flow.

The pair of sealing surfaces according to the invention by abutment of the individual sealing surfaces provides a seal for locking the fluid flow through the inlet into the interior. Preferably this seal is achieved by abutment of the housing and closure element body.

According to the invention, the closure element can be designed without regions having a shorter distance from the axis or centre point of the sphere than the distance from the sealing surface. A free space can also be formed by recesses in the housing, where regions having a greater distance from the axis or centre point of the sphere than the distance of the sealing surfaces from the axis or the centre point of the sphere can be provided in the closure element. In this case, but also in the case of recesses in the closure element, the closure element can be provided with one or more passages (e.g. holes or slots) which form a fluid-conducting connection between inlet and free space. Also in this way a dead space in the open position due to the flow of fluid via the passages, via the free space to the outlet can be avoided. The closure element can be provided with a through hole having full or reduced cross-section with or without flow inserts. In this case, the free space is preferably produced in the housing interior by greater distances from the centre point than the distance of the sealing surfaces from the centre point or from the axis.

The closure element according to the invention can be without regions having a shorter distance from the axis than the distance from the sealing surface in such a manner that no through hole is provided in the closure element and therefore the entire product flow is guided via holes or slots from the inlet via the free space into the outlet.

The sealing effect is preferably achieved by using sealing elements such as plastic, rubber, graphite, ceramic, sintered material, composite material or metal seals, also a design in which housing part and shut-off part produce the sealing effect without additional sealing element is also feasible according to the invention. Preferably the sealing surfaces of the housing and/or the closure element are provided on a sealing projection. In addition to this projection, the free space can thus be formed over a large area in other regions.

Preferably a recess is provided on the outer area when viewed inside the sealing surface of the closure element. This recess allows a flow of fluid when this part (with the sealing surface) of the closure element is oriented in the direction of a sealing surface of the housing—where the pair of sealing surfaces does not abut. This position enables a rinsing of the free space in the open or partially open position of the shut-off member.

In preferred embodiments of the present invention, the sealing surfaces of the housing and/or the closure element, in particular on a sealing projection, are circular or annular in view.

In further preferred embodiments, the sealing projection of the housing and/or the closure element is annular, e.g. circular or oval.

In particular, according to the present invention, the sealing surfaces are at the inlet, where the outlet is free from any sealing element (such as, for example, sealing surfaces). According to the invention, this is intended to achieve that in each rotation position of the shut-off element the free space is connected to the outlet so that fluid can emerge at any time.

In preferred embodiments the free space is formed by a recess, in particular a recess delimited by the sealing surface or the sealing projection. The recess can be provided on the housing or on the closure element or on both parts. On the valve housing the recess is formed towards the interior or on the closure element the recess is provided so that the free space is formed between the housing and the closure element.

In preferred embodiments the recess of the closure element is hemispherical, partially spherical, cylindrical or curved.

The interior can be partially spherical or cylindrical. The shape of the interior is preferably adapted to the shape of the closure element with a precisely defined distance from one another in the region of the free space. In particular embodiments of the present invention, the distance can be in the region of 0.5 mm to 20 mm, preferably of 0.8 mm to 18 mm, of 1 mm to 15 mm, of 1.5 mm to 10 mm or of 2 mm to 6 mm.

In preferred embodiments the closure element is partially spherical. The free space of these part-spheres spatially preferably surrounds the entire closure element—apart from the axial region in which the closure element is fastened—at least in a partially open position, e.g. with an opening of about 45°. In partially spherical embodiments, the shut-off member according to the invention is also designated as ball valve.

The closure element can be mounted by an axial shaft and positioned rotatably in the interior of the valve housing. Preferably the rotation of the closure element enables rotations about 90°, 180 or 360°.

In preferred embodiments of the present invention, the closure element has a hole for flow of a fluid between inlet and outlet in the open position of the device, where optionally further connecting holes connect the hole to the free space in a fluid-conducting manner. According to a special embodiment, the present invention relates to a ball valve which comprises a housing having a partially spherical interior as well as an inlet and outlet and a partially spherical plug as closure element, which is accommodated rotatably about an axis in the interior, where the housing towards the interior and/or the plug towards the housing has a recess delimited by a sealing projection which in the closed position of the plug is connected to the outlet, which in an at least partially open position of the plug allows a flow of a fluid between inlet and outlet. Further connecting holes can connect this flow to the free space in a fluid-conducting manner for a better rinsing of the free space with fluid and to avoid dead spaces in the completely open position (e.g. 90° with a shut-off member with opposite inlets and outlets).

In preferred embodiments the hole is formed between inlet and outlet for an increased flow resistance, e.g. a constriction (13) and/or a flow resistance element, preferably a perforated plate, can be provided before the outlet. As a result, the pressure is increased and larger quantities of fluid are guided through the free spaces than without such resistances in the case of a uniform hole having constant diameter between inlet and outlet.

The invention also relates to a ball valve which comprises a housing having a partially spherical interior as well as an inlet and outlet and partially spherical plug as closure element, which is accommodated rotatably about an axis in the interior, where the housing towards the interior and/or the plug towards the housing has a recess delimited by a sealing projection which in an at least partially open position of the plug allows a flow of a fluid between inlet and outlet, where the recess is connected to the outlet in the closed position and in the open position of the plug. Preferably in an open or partially open position of the closure element, the recess allows a flow of a fluid between inlet and outlet via the recess.

In preferred embodiments the hole centrally crosses the closure element, particularly preferably the axis is crossed centrally. An axial shaft can be provided right through the closure element. In other embodiments the interior of the closure element has no shaft. The shaft can also be attached outside to the closure element.

In one embodiment the closure element is a solid body—without any hole or through hole normal to the axis. In this embodiment substantially the entire fluid flow is guided via the free space which is formed here by the recess. Accordingly, the invention also relates to a shut-off member which comprises a housing having an interior as well as at least one inlet and at least one outlet and a plug as shut-off element, which is mounted rotatably about an axis in the interior, wherein between the plug and the housing there is a free space for flow of a fluid between inlet and outlet and a sealing projection is provided around an inlet or outlet, and where the plug has a locking element which is pivotable by rotation of the plug and in the locking position of the shut-off valve shuts off an inlet or outlet by fluid-tight contact with the sealing projection.

In an arbitrary embodiment of the invention, the valve housing and/or the closure element are preferably formed from a metal or a metal alloy, preferably where this is iron-containing. Metal alloys or metal ions dissolved therefrom can serve as a catalyst for chemical reactions, including for explosion-like reactions. When using metals, the avoidance of dead spaces and deposits in the shut-off member according to the invention is therefore particularly advantageous in order to avoid such reactions. The valve housing and/or the closure element can be made of various materials such as steel, stainless steel, ceramic, sintered metals, aluminium, plastic, composite materials, non-ferrous metals or noble metals. Preferred materials are all irons, iron alloys, chromium nickel steels, nickel steels (e.g. Hastelloy materials), titanium, tantalum, silicon carbide, glass, ceramic, gold, platinum and also plastics. Special materials are alloys having a high molybdenum content or nickel, chromium, and molybdenum alloys for resistance to pitting and gap corrosion or nickel-copper alloys having a high tensile strength. Material examples are Hastelloy C (high corrosion strength), Hastelloy B (precipitation-hardening high-temperature alloy), Inconel (resistance to stress corrosion cracks in petrochemical applications), Incoloy (high strength and also resistance to high temperatures and to oxidation and carburisation), Monel (high tensile strength, resistant to corrosion). The valve housing and/or the closure element can however also be made of coated materials. In order to improve the sealing effect, the closure element, possibly also the valve housing, can be designed to be hardened. In addition, closure element and/or valve housing can additionally be polished at least partially, in particular in the region of the sealing surfaces.

Preferably the diameter of the closure element is between 0.5 cm to 100 cm, preferably between 1 cm to 80 cm, between 2 cm and 50 cm, between 3 cm and 30 cm or between 5 cm and 20 cm.

Arbitrary fluids can be guided through the shut-off member according to the invention between inlet and outlet. Preferably fluid is guided from the inlet to the outlet. The flow direction can also be reversed, i.e. from the outlet to the inlet. The shut-off member can be provided in a line, in particular a pipeline. One or more excess pressure relief devices can be provided in the line, preferably excess pressure relief devices based on bursting elements. The use of excess pressure relief devices is generally known. Usual means comprise, for example, bursting disks which comprise a membrane which bursts under the action of a pressure which is higher than the normal operating pressure but lower than the pressure at which a pipe or vessel itself ruptures, whereby pressure can be relieved with an external space. Bursting disks are described, for example, in U.S. Pat. No. 6,241,113, U.S. Pat. No. 3,845,879, US 2008/0202595, EP 1 591 703 and U.S. Pat. No. 7,870,865, U.S. Pat. No. 4,079,854, U.S. Pat. No. 3,872,874, WO 2005/054731, EP 789 822. U.S. Pat. No. 5,337,776 relates to a pipeline having an excess pressure relief device where a bursting disk lies flush in the inner side of the wall of the pipe so that rinsing of the bursting disk with transported liquid is accomplished.

In preferred embodiments of the invention, a line according to the invention comprises at least two of the shut-off members according to the invention, in particular two, three, four, five, six or more shut-off members. In particular embodiments at least one of the shut-off members is a three-way shut-off member, e.g. having one inlet and two outlets or having two inlets and one outlet. In combination or alternatively to this in particular embodiments, one of the shut-off members is a two-way shut-off member having one inlet and one outlet.

The invention further relates to the use of the shut-off member for controlling the flow (e.g. for locking or releasing) of a fluid and a correspondingly designed closure element or a correspondingly designed interior of the shut-off member. Preferably process parameters are selected wherein in an open position or free-space rinsing position (e.g. upon rotation of the closure element by 15°-75° of the closure element
the differential pressure between inlet and outlet formed by the shut-off member is at least 0.4 bar;
the rinsing flow ratio formed by the free space flow divided by the flow through the hole (10) is at least 0.1%;
the nominal gap speed formed by the free space flow divided by the free space cross-section is at least 0.1 m/min; and/or
the free space exchange rate formed by the free space flow divided by the free space volume is at least 1 l/min.

The differential pressure between inlet and outlet which is formed by the shut-off member should be at least 0.4 bar, preferably at least 0.5 bar, at least 0.7 bar, at least 0.8 bar, at least 1 bar. As a result of a higher differential pressure between inlet and outlet, a larger fraction of fluid is guided through the free space to avoid dead zones, alternatively to the direct flow between inlet and outlet through the hole through the closure element.

Associated with this, the rinsing flow ratio formed by the free space flow divided by the flow through the hole through the closure element is at least 0.1%, preferably at least 0.2%, at least 0.3%, at least 0.5%, at least 0.75%, at least 1% or at least 1.5%.

The nominal gap speed formed by the free space flow divided by free space cross-section is preferably at least 0.05 m/min, particularly preferably at least 0.1 m/min, at least 0.75 m/min or at least 1 m/min.

The free space exchange rate formed by the free space flow divided by the free space volume is preferably set so that it is at least 1 l/min, preferably at least 1.5 l/min or at least 2 l/min.

These parameters are closely related to the pressure resistance in the hole (if this is present). By means of structural elements to increase this pressure resistance, the parameters can be increased and therefore higher flow rates guided via the free space. Such elements are preferably constrictions of the hole before the outlet (but after corresponding branchings for rinsing the free space) or resistance elements such as perforated plates. It is also possible to increase the pressure resistance by turning the closure element from the completely open position (rinsing position e.g. 15°-75° in order to thus allow higher flow rates in the free space.

The invention further provides a shut-off member in which when using a fluid comprising 12.9% cellulose; 76.3% NMMO (N-methyl morpholin-N-oxide); 10.8% water at 94° C., the said parameters selected from differential pressure, rinsing flow ratio, nominal gap speed and/or free space exchange rate are satisfied. Such configurations of the shut-off member can be tested as described in the examples.

The geometry of the shut-off member is preferably designed in such a manner that:
free spaces are created between closure element and housing of the shut-off member.
The free spaces have supply and drain openings so that no dead spaces with fluid can be formed.
The free spaces are through-rinsed directly by partial flows or by the entire flow of through-flowing fluid.

On the basis of the selected geometry, the shut-off member should be designed so that a sufficient driving pressure difference prevails between inlet and outlet of the shut-off member which ensures a reliable rinsing of the free spaces, especially in the case of unstable fluids.

In order to determine the suitable configuration and the suitable process parameters (throughput, pressure difference), according to the invention the rinsing flow ratio (FV), the nominal gap speed (v_{F}), the free space exchange rate (FA) and the rinsing number (SZ) (as described in detail in Example 1) should lie above the values according to the invention.

In a particularly preferred aspect the invention relates to the use of a shut-off member in a line, in particular during transport of chemically unstable fluids. In this case, preferably the shut-off member according to the invention is used, where fluid flows via the inlet into the shut-off member and emerges via the outlet from the shut-off member. Usually for this purpose the fluid pressure at the inlet is greater than at the outlet. In alternative embodiments, the direction of flow can also be reversed and fluid can enter at the outlet and leave at the inlet (with the sealing surfaces).

Fluids for which the use of the shut-off member according to the invention is shown to particular advantage are chemically unstable fluids which are corrosive or prone to explosion when deposited in the shut-off member.

In particularly preferred embodiments the fluid is a moulding compound, preferably a spinning compound. For example, the fluid can be a cellulose solution, preferably a solution of cellulose with an amine oxide, particularly preferably with NMMO (N-methylmorpholin-N-oxide).

Preferably the chemically unstable fluid is thermally unstable. Thermally unstable fluids are, for example, cellulose solutions such as cellulose amine-oxide solutions, especially solutions of tertiary amine oxide and water. Along with stabilisers such as, for example, gallic acid propyl ester, such solutions can contain organic or inorganic bases such as, for example, sodium hydroxide solution. Furthermore, such cellulose/amine oxide and water solutions can also contain product-changing additives, so-called incorporation media. Cellulose solutions produced in an amine oxide system are characterised in that they crystallise during cooling but can be molten at a temperature of about 72-75° C. An example is a cellulose-NMMO solution as described in EP 789 822. The fluid can be an aqueous amine oxide solution having different concentrations. Thermally unstable fluids are those in which there is a risk of an increase in temperature during transport through the connecting piece or the heat exchanger line. Increases in temperature can occur, for example, as a result of exothermic reactions, in particular chemical reactions or as a result of frictional heat during transport of highly viscous fluids. Other fluids are in particular solidifiable fluids, in particular “hot-melts” such as polymers, polycarbonates, polyester, polyamide, polylactic acid, polypropylene etc. The fluid can be a thixotropic fluid, in particular a spinning solution. Special fluids have a melting point of at least about 40° C., at least 50° C., at least 55° C., at least 60° C., at least 65° C., at least 70° C., at least 75° C. The fluid can be guided at exemplary temperatures of at least about 40° C., at least 50° C., at least 55° C., at least 60° C., at least 65° C., at least 70° C., at least 75° C., at least about 80° C., at least 85° C., at least 90° C., at least 95° C. The connecting piece is designed for transporting these fluids above the melting points—e.g. according to selected temperature-control means. Preferably the zero-shear viscosity of the fluid is in the range of 10 to 25,000 Pas, in particular between 50 and 20,000 Pas.

In a further aspect, the present invention relates to a method for producing moulded bodies from a fluid moulding compound comprising transporting a fluid moulding compound through a line having a shut-off member according to the invention, wherein the line leads to a moulding unit, in particular an extruder having openings through which the moulding compound is pressed and thereby moulded, and hardening the moulding compound, preferably by solidification or coagulation. Preferably the line is a pipeline. The line can be connected to the moulding unit via the outlet of the shut-off member. The direction of flow can be reversed where in this embodiment the inlet (with the sealing surfaces) is connected to the moulding unit via the line.

Moulding units are sufficiently known, e.g. as described in EP 0 700 463 B1, EP 0 671 492 B1, EP 0 584 318 B1 or EP 1 463 851 B1. The moulding unit preferably comprises openings through which the mass is moulded, in particular an extrusion unit, an air gap, through which the moulded shaped bodies are guided and a coagulation bath in which the shaped bodies solidify, e.g. by exchange of solvent.

The present invention is explained further in detail by the following figures as examples without being restricted to these embodiments of the invention.

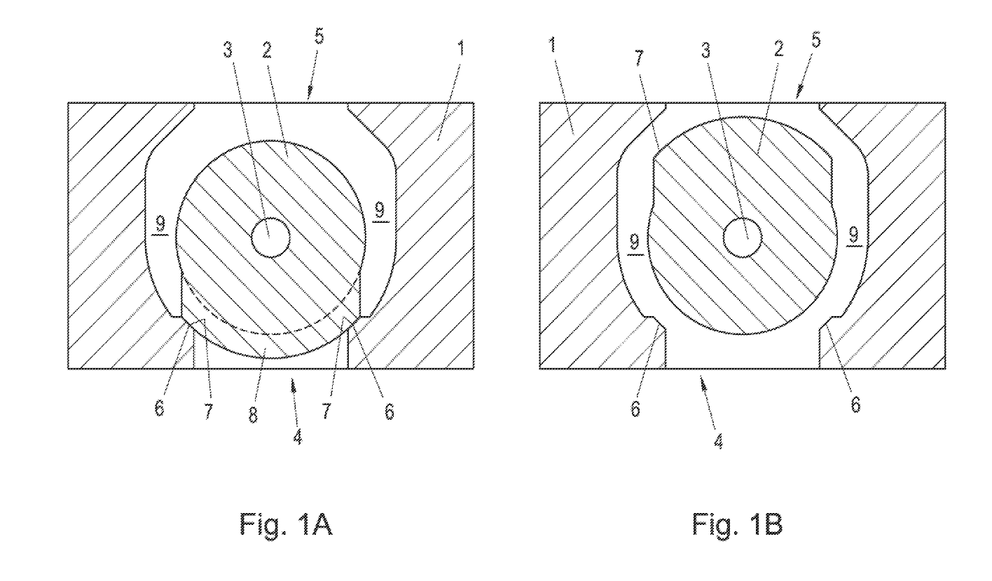

FIG. 1 shows a section through a shut-off member according to the invention comprising a valve housing (1), a solid closure element (2) which is mounted on a shaft (3) in the interior of the housing. An inlet (4) and an outlet (5) of the shut-off member lead to the interior. In the locking position (FIG. 1A) a sealing surface (6) of the housing lies with a sealing surface (7) of the closure element against one another. In the open position (FIG. 1B) the sealing surface (7) of the closure element is directed away from the sealing surface (6) of the housing. The sealing surfaces of the closure element are provided on a projection (8) which has a greater distance (radius) from the axis or the centre point than other regions of the closure element. These other regions of the closure element can also be considered as a recess compared to the projection (8). Likewise the sealing surface of the housing is provided on a projection which delimits a free space (9) leading to the outlet.

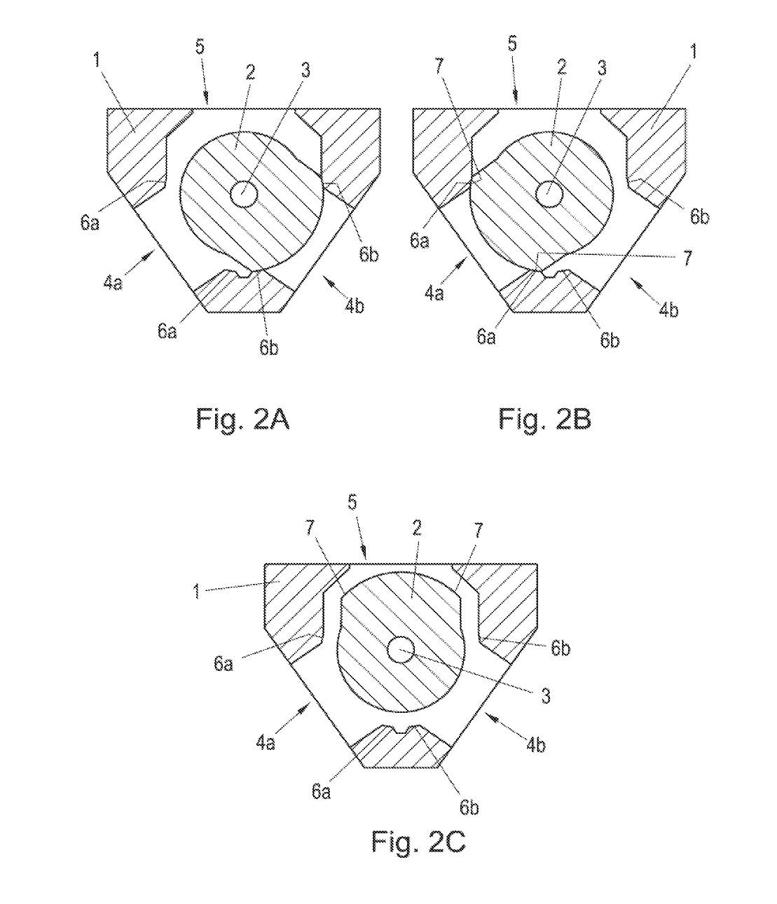

FIG. 2 shows a similar shut-off member as described in FIG. 1 with the difference that this shut-off member is a three-way device with two inlets (4a, 4b). Each inlet has its own sealing surfaces (6a, 6b). The closure element can alternately block one of the two inlets by rotation (FIGS. 2A and 2B) or release both inlets (FIG. 2C), whereby the sealing surfaces of the closure element are directed away from both inlets.

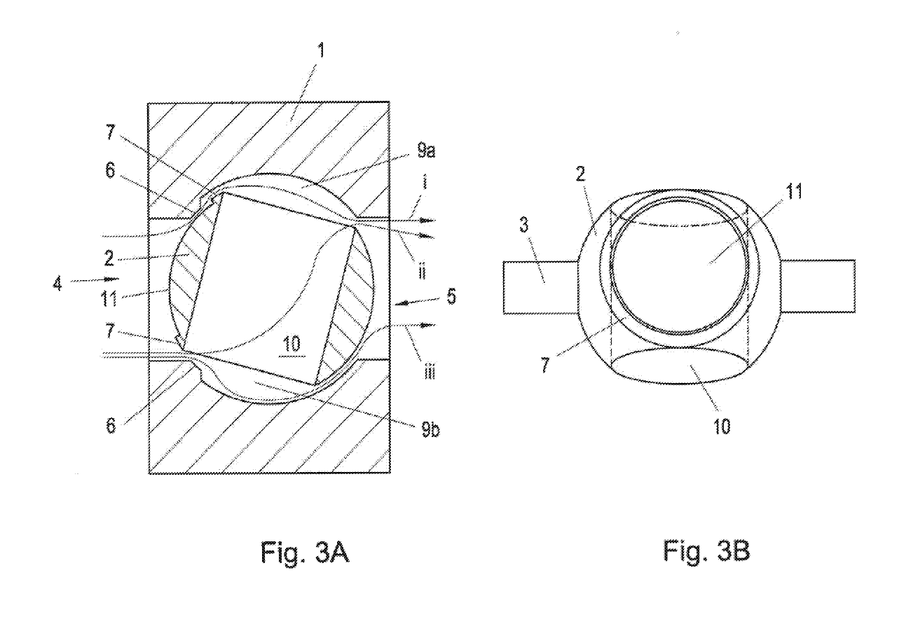

FIG. 3A shows a section through a shut-off member according to the invention comprising a valve housing (1), a solid closure element (2) which is mounted on a shaft (3) in the interior of the housing. In this embodiment the shaft is not continuous, i.e. it is mounted externally on the closure part body so that the flow hole (10) remains free. An inlet (4) and an outlet (5) of the shut-off member lead to the interior. Sealing surfaces (6) of the housing are provided on a projection or the remaining space around the closure element is a recess. Likewise the annular sealing surface of the closure element is provided on a projection. A recess (11) is provided in the edge region of the closure element between or inside the sealing surface. A flow hole (10) for the main flow of fluid through the closure element is provided through the closure element. In addition, the possible flow directions for the fluid from the inlet to the outlet are indicated in FIG. 3 and specifically i) via the free space 9a, ii) via the flow hole (10) and then via the free space 9a and iii) via the free space 9b.

FIG. 3B shows the spatial view of the closure element of the shut-off member from FIG. 3A viewed in the direction from the inlet onto the closure element which is designed to be partially spherical.

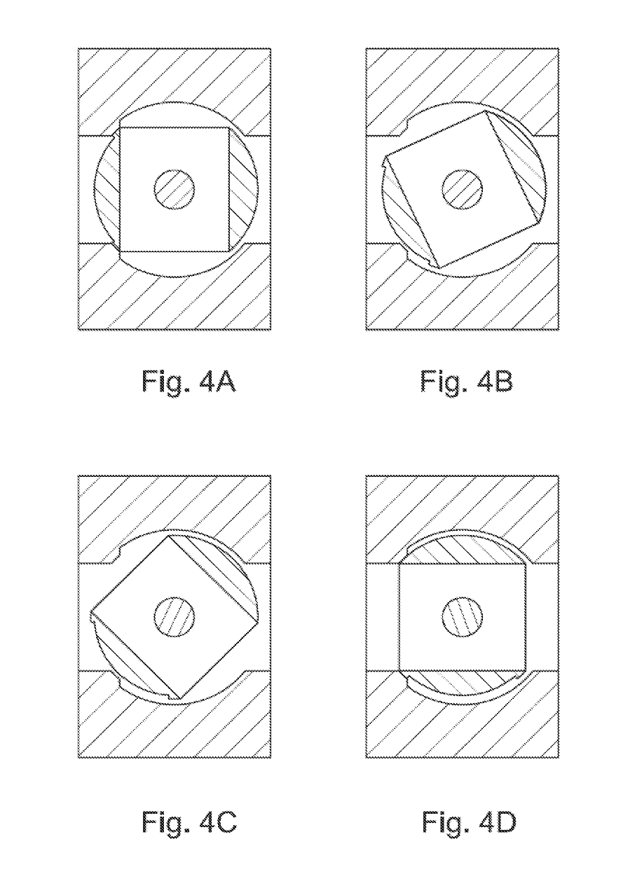

FIG. 4 shows the ball valve of FIGS. 3A and 3B in different rotational orientations of the closure element 4A 0° (locking position), 4B 25° (partially open), 4C 45° (partially open) and 4D 90° (completely open position); in the partial open positions, the free space around the closure element is rinsed, in the completely open position the free space is further connected to the outlet in a fluid-conducting manner.

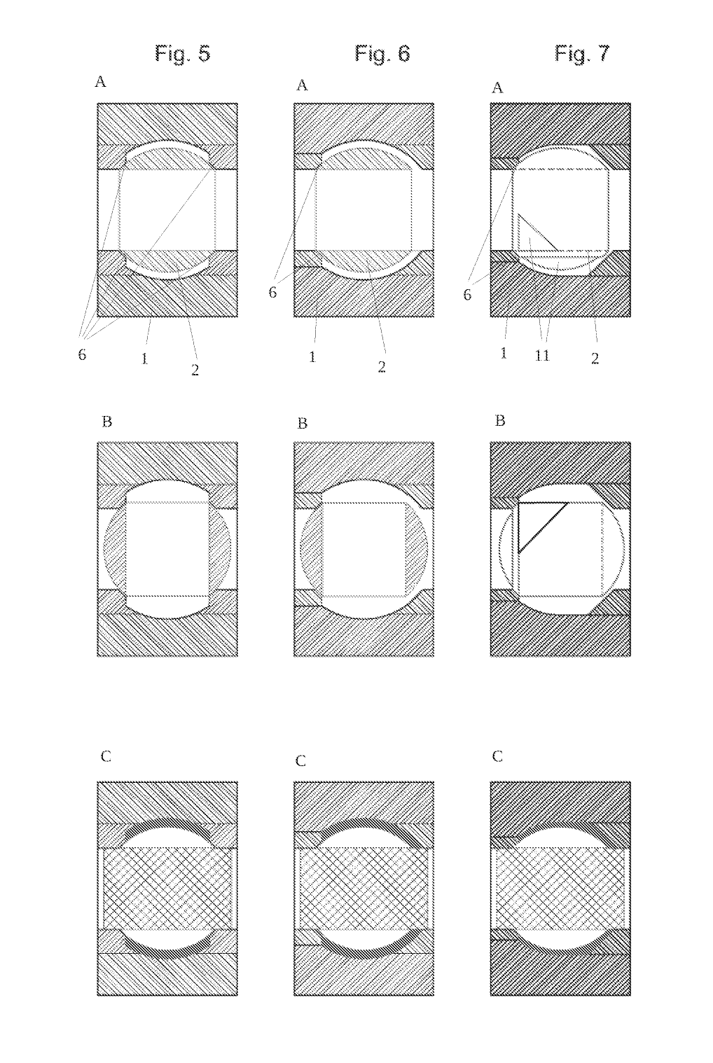

FIG. 5 shows for comparison, a ball valve with two pairs of sealing surfaces (6) at the inlet and outlet. A: completely open position, B: closed position, C: open position where the course of the through-flow stream is shown crossed/hatched and the rinsing flow (free space volume) is shown emphasized in black.

FIG. 6 shows a ball valve having a sealing surface (6) at the inlet. A, B and C are similar to FIG. 5.

FIG. 7 shows a ball valve having a sealing surface (6) at the inlet. The free space is formed by recesses (11) on the housing and on the closure element (2, 11). A, B and C are similar to FIG. 5.

FIG. 8 shows a ball valve with a sealing surface (6) at the inlet. In addition, holes (12) as inflow to the free space are provided in the vicinity of the inlet after the sealing surfaces. A, B and C are similar to FIG. 5.

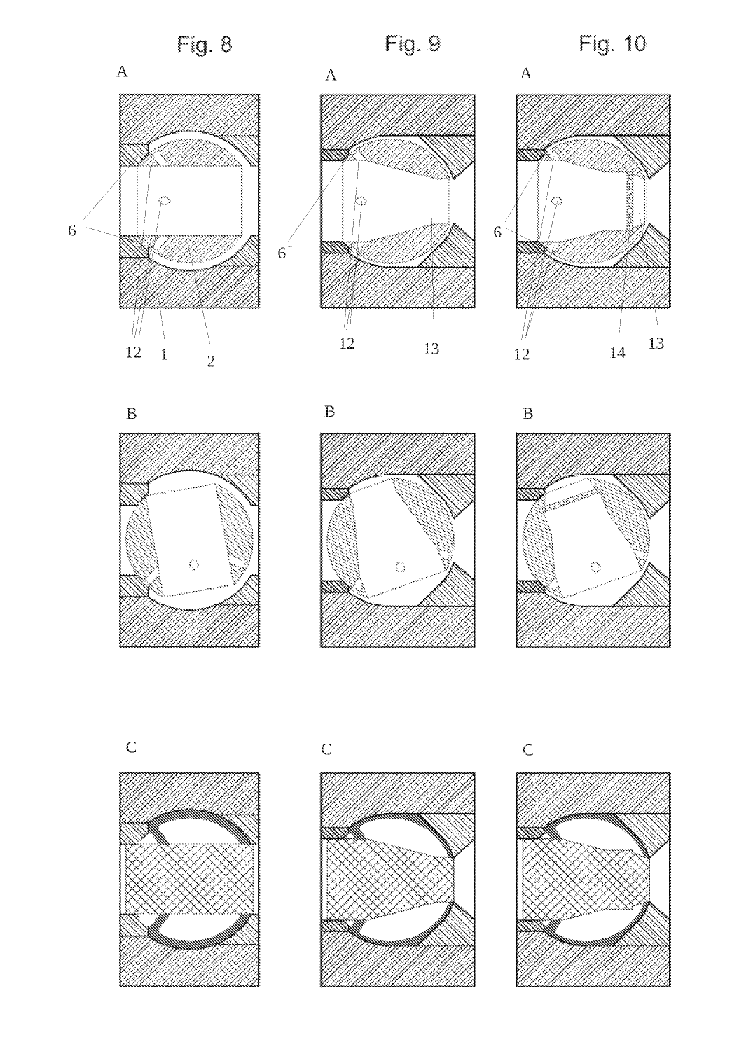

FIG. 9 shows a ball valve with a sealing surface (6) at the inlet. In addition, holes (12) as inflow to the free space can be provided in the vicinity of the inlet after the sealing surfaces and furthermore a constriction (13) is provided in the through hole. A, B and C are similar to FIG. 5.

FIG. 10 shows a ball valve with a sealing surface (6) at the inlet. In addition, holes (12) as inflow to the free space are provided in the vicinity of the inlet after the sealing surfaces and furthermore a constriction (13) and a perforated sheet (14) are provided in the through hole. A, B and C are similar to FIG. 5.

FIG. 11 shows a ball valve with a sealing surface (6) at the inlet. In addition, holes as access to the free space are provided in the vicinity of the inlet after the sealing surfaces. No through hole is provided centrally through the closure element. A, B and C are similar to FIG. 5.

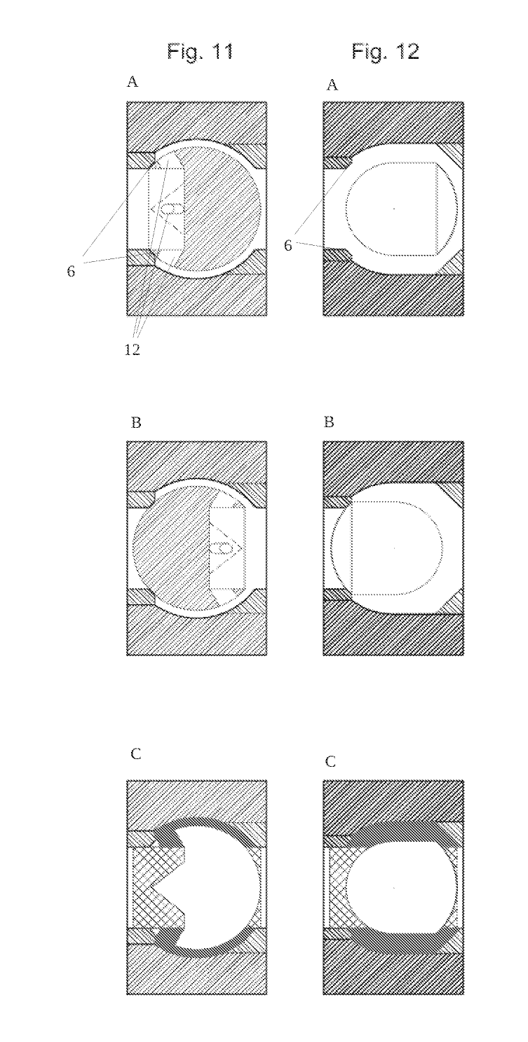

FIG. 12 shows a ball valve with a sealing surface (6) at the inlet. The flow is guided entirely via the free spaces (as in FIG. 1). A, B and C are similar to FIG. 5.

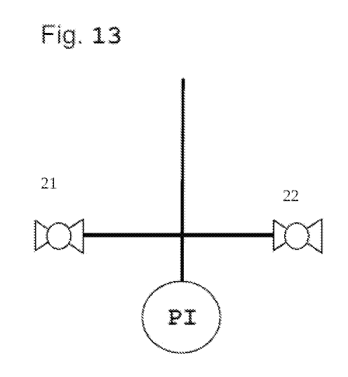

FIG. 13 shows a measurement arrangement to determine characteristic parameters of various embodiments of the shut-off member. The measurement arrangement contains a fluid supply and drain and the shut-off member (21) as well as a further shut-off member (22) and a pressure gauge (PI).

### EXAMPLES

### Example 1

### Flow Parameters for Viscous Fluids

In order to determine the configuration of the shut-off member according to the invention, it is necessary to adapt the internal geometry of the shut-off member to the process conditions. If merely a standard fitting were to be used, disregarding the process and medium parameters, variation of the medium or the flow rate would result in operating states which no longer ensure a safe control of the process.

The precise geometric design of the shut-off member should therefore be adapted to process conditions corresponding to relationships according to the invention. If a configuration (the combination of geometrical parameters of the shut-off member and the given process parameters such as viscosity, shear behaviour, temperature, . . . ) does not correspond to the parameters according to the invention, the exchange of fluid in the free space volume can be too small to avoid exothermic reactions which occur with depositions of thermally unstable fluids such as, for example, cellulose/NMMO/water mixtures.

For the “tailor-made” configuration, experiments were carried out under operating conditions in order to determine the optimal geometry so that on the one hand the rinsing of the free spaces is accomplished to a sufficient extent but on the other hand tolerable (not too high) pressure losses occur on passage through the shut-off member.

The relationships between gap geometry, geometry of the closure element as well as material parameters of the fluid to be transported were found by iterative approximation of the geometries.

The following procedure was adopted for adaptation of the geometries to the operating conditions:

Fluid was supplied to the experimental arrangement (see FIG. 13) under operating conditions (composition, temperature, flow rate).

In a first step the throttling device (21) remains closed and the entire quantity of fluid (V_{P} [dm³/min]) is guided via the open shut-off member (22) to be configured. Pressure (p [bar]) and flow rate (V_{P} [dm³/min]) are determined and recorded.

In the next step the throttling device (21) is opened sufficiently far that the previously determined pressure is set. In the shut-off member to be configured, the closure element is closed on the passage side so that fluid is only guided via the free spaces (rinsing gap). The free-space flow (V_{F} [dm³/min]) is measured.

The following values are calculated from the measured values:
Gap speed (v_{F} [m/min]) (note: >0.1):
Free space flow (V_{F} [dm³/min]) divided by free space cross-section, where the free space cross-section is calculated from n divided by 4 multiplied by the difference of the housing diameter squared (D_{G}² [dm²]) minus the closure element diameter in the passage position squared (D_{V}² [dm²]).
Free space exchange rate (FA [1/min]) (note: >1):

Free space flow (V_{F} [dm³/min]) divided by the free space volume (Fₜₒₜ [dm³])
Rinsing flow ratio (FV [%]):
Free space flow (V_{F} [dm³/min]) divided by product flow (V_{P} [dm³/min])
Rinsing number (SZ) (note: >0):
Logarithm of the result of 1000 times rinsing flow ratio (FV [%]) multiplied by gap speed (v_{F} [m/min]) divided by free space exchange rate (FA [1/min])

It has been found that the free space (also called rinsing gap or gap) alone is not sufficient to achieve a sufficient dead-space-free rinsing of this free space in the case of the said cellulose/NMMO/water mixture. Only by suitable measures which increase the pressure gradient between inlet and outlet of the shut-off member, was it possible to achieve the inventive characteristic values for gap speed (v_{F} [m/min], free space exchange rate (FA [1/min]) and for the rinsing number (SZ) and thereby enable secure transport of viscous unstable fluids. Suitable measures for providing the required differential pressure are:
1) Reduction of the transmitted product flow by periodic throttling of the closure element
2) Reduction of the passage diameter of the closure element
3) Insertion of a resistance in the passage diameter of the closure element
4) Guiding the entire product flow via the rinsed free space

### Examples 2-9

An extrusion solution consisting of cellulose, NMMO and water having a cellulose concentration of 12.5% was used at a temperature of about 94° C. to verify the usability of the shut-off member.

TABLE

| Example | | | 2 | 3 | 4 | 5 | 6 | 7 | 8 | 9 |
|---|---|---|---|---|---|---|---|---|---|---|
| Nominal diameter | DN | mm | 63 | 63 | 63 | 54 | 63 | 63 | 63 | 63 |
| Product flow | V_{P} | dm³/min | 7.27 | 10.55 | 5.98 | aar | 7.11 | 5.21 | 4.95 | 5.74 |
| Flow rate | V_{N} | m/min | 2.33 | 3.38 | 1.92 | 3.19 | 2.28 | 1.67 | 1.59 | 1.84 |
| Differential pressure | p | bar | 0.2 | 0.3 | 2.8 *) | 0.3 | 1.4 | 2.6 | 2.8 | 0.5 |
| Transmitted volume flow | V_{D} | dm³/min | 7.27 | 10.55 | 5.85 | 7.28 | 6.93 | 5.05 | | |
| Free space flow | V_{F} | dm³/min | — | — | 0.13 | 0.02 | 0.18 | 0.16 | 4.95 | 5.74 |
| Rinsing flow ratio | FV | | 0.0% | 0.0% | 2.1% | 0.3% | 2.5% | 3.1% | 100% | 100% |
| Diameter housing interior | D_{G} | mm | 105 | 105 | 102 | 108 | 105 | 102 | 111 | 102 |
| Diameter closure element | D_{V} | mm | 96 | 96 | 96 | 96 | 96 | 96 | 96 | 72 |
| in passage position | | | | | | | | | | |
| Nominal gap speed | V_{F} | m/min | — | — | 0.13 | 0.01 | 0.13 | 0.17 | 2.03 | 1.40 |
| Free space volume total | Fₜₒₜ | cm³ | 123 | 140 | 59 | 150 | 87 | 67 | 164 | 329 |
| Free space exchange rate | FA | 1/min | — | — | 2.13 | 0.13 | 2.05 | 2.43 | 30.14 | 17.47 |
| Rinsing number | SZ | | — | — | 0.123 | −0.677 | 0.184 | 0.345 | 1.828 | 1.904 |

*) About 15° open

### Example 2

### FIG. 5

A conventionally equipped ball valve with heated housing, closure element (sphere) with free passage and inlet- and outlet-side seal which together with the sphere surface and the housing interior form a closed cavity was installed and tested in the experimental arrangement described further above.

The ball valve had a nominal diameter of 63 mm, the housing inside diameter (D_{G}) was 105 mm, the diameter of the closure element transverse to the direction of passage (D_{V}) was 96 mm. The free space volume (Fₜₒₜ) through which no flow took place was 123 cm³. A product flow (V_{P}) of 7.3 dm³/min was passed therethrough. At a nominal flow rate (v_{N}) of 2.33 m/min, this yielded a pressure loss (p) of about 0.2 bar.

Since no rinsing of the free space behind the seals took place, the rinsing flow ratio, the nominal gap speed and the free space exchange rate should be set to 0 so that no rinsing number could be determined.

The shut-off member was verified as not suitable for the particular use.

### Example 3

### FIG. 6

A ball valve as in Example 2 but without outlet-side free space seal (open free space) was tested.

The free space volume (Fₜₒₜ) through which no flow took place was 140 cm³. A product flow (V_{P}) of 10.55 dm³/min was passed therethrough. At a nominal flow rate (v_{N}) of 3.38 m/min, this yielded a pressure loss (p) of about 0.3 bar.

Since no rinsing of the open free space took place, the rinsing flow ratio, the nominal gap speed and the free space exchange rate should be set to 0 so that no rinsing number could be determined.

The shut-off member was verified as not suitable for the particular use in the open position (90°). In order to enable rinsing of the free space, it is necessary to twist the closure element into a rinsing position (15°-75° where the free space can only be partially rinsed due to the unfavourable flow relationships.

### Example 4

### FIG. 7

A ball valve according to Example 3 but having a closure element with regions having a shorter distance from the axis than the distance from the sealing surface was installed and tested in the experimental arrangement described further above.

Since no rinsing of the free space was possible in the open state, the ball valve was closed at recurrent intervals (3 to 4 hours) for rinsing up to an opening angle of about 10 to 15°.

The ball valve had a nominal diameter of 63 mm, the housing inside diameter (D_{G}) was 102 mm, the diameter of the closure element transverse to the direction of passage (D_{V}) was 96 mm. The free space volume (Fₜₒₜ) through which flow took place at periodic intervals was 59 cm³. A product flow (V_{P}) of 5.98 dm³/min was passed therethrough. At a nominal flow rate (v_{N}) of 1.92 m/min, this yielded a pressure loss (p) of about 2.7 bar.

Since the rinsing of the free space behind the seal took place periodically, the characteristics were determined during the rinsing process, a rinsing flow ratio (FV) of 2.1% was obtained, the nominal gap speed (v_{F}) was 0.13 m/min, the free space exchange rate (FA) was calculated to a value of 2.13, thus giving a rinsing number (SZ) of 0.123.

The shut-off member was verified as suitable for the particular use, this is confirmed by the characteristics determined.

### Example 5

### FIG. 8

A ball valve according to Example 3 but provided with a ball which had radially arranged holes for connection of the passage space to the free space was subjected to the tests specified above. The holes were arranged in such a manner that a partial flow of the product flow was guided directly onto the sealing lip of the free space and therefore both seal and also free space could be continuously rinsed.

The closure element (the ball) had a continuously free passage of 54 mm.

The ball valve had a nominal diameter of 54 mm, the housing inside diameter (D_{G}) was 105 mm, the diameter of the closure element transverse to the direction of passage (D_{V}) was 96 mm. The free space volume (Fₜₒₜ) through which flow took place was 150 cm³.

A product flow (V_{P}) of 7.29 dm³/min was passed therethrough. At a nominal flow rate (v_{N}) of 3.19 m/min, this yielded a pressure loss (p) of about 0.3 bar.

The rinsing of the free space behind the seal took place continuously, the following characteristics were determined: a rinsing flow ratio (FV) of 0.3%, the nominal gap speed (v_{F}) was 0.01 m/min, the free space exchange rate (FA) was calculated to a value of 0.13, thus giving a rinsing number (SZ) of −0.677.

Although rinsing channels were provided, as a result of the low rinsing of the free space in the complete open position, a reliable through-rinsing cannot be assumed so that this configuration is not suitable for use. In order to enable a rinsing of the free space, it is necessary to twist the closure element into a rinsing position (15°-75° where dead spaces can nevertheless form in regions behind the seal between the holes (12).

### Example 6

### FIG. 9

The closure element (the ball) had a tapering through hole in the direction of flow to increase the pressure gradient.

The ball valve had a nominal diameter of 63 mm, the housing inside diameter (D_{G}) was 105 mm, the diameter of the closure element transverse to the direction of passage (D_{V}) was 96 mm. The free space volume (Fₜₒₜ) through which flow took place was 87 cm³. A product flow (V_{P}) of 7.11 dm³/min was passed therethrough. At a nominal flow rate (v_{N}) of 2.28 m/min, this yielded a pressure loss (p) of about 1.4 bar.

The rinsing of the free space behind the seal took place continuously, the following characteristics were determined: a rinsing flow ratio (FV) of 2.5%, the nominal gap speed (v_{F}) was 0.13 m/min, the free space exchange rate (FA) was calculated to a value of 2.05, thus giving a rinsing number (SZ) of 0.184.

The shut-off member was verified as suitable for the particular use, this is confirmed by the characteristics determined.

### Example 7

### FIG. 10

A ball valve according to Example 6 but in addition to the tapering through hole, a resistance element (perforated plate) was also inserted in the hole of the ball.

The ball valve had a nominal diameter of 63 mm, the housing inside diameter (D_{G}) was 102 mm, the diameter of the closure element transverse to the direction of passage (D_{V}) was 96 mm. The free space volume (Fₜₒₜ) through which flow took place was 67 cm³.

A product flow (V_{P}) of 5.21 dm³/min was passed therethrough. At a nominal flow rate (v_{N}) of 1.67 m/min, this yielded a pressure loss (p) of about 2.6 bar.

The rinsing of the free space behind the seal took place continuously, the following characteristics were determined: a rinsing flow ratio (FV) of 3.1%, the nominal gap speed (v_{F}) was 0.17 m/min, the free space exchange rate (FA) was calculated to a value of 2.43, thus giving a rinsing number (SZ) of 0.345.

The shut-off member was verified as suitable for the particular use, this is confirmed by the characteristics determined.

### Example 8

### FIG. 11

A ball valve according to Example 6 but the passage hole was completely closed so that the entire product flow was guided via the radially outwardly running rinsing holes through the free space to the drain of the shut-off member.

The ball valve had a nominal diameter of 63 mm, the housing inside diameter (D_{G}) was 111 mm, the diameter of the closure element transverse to the direction of passage (D_{V}) was 96 mm. The free space volume (Fₜₒₜ) through which flow took place was 164 cm³.

A product flow (V_{P}) of 4.95 dm³/min was passed therethrough. At a nominal flow rate (v_{N}) of 1.59 m/min, this yielded a pressure loss (p) of about 2.8 bar.

The following characteristics were determined: a rinsing flow ratio (FV) of 100%, the nominal gap speed (v_{F}) was 2.03 m/min, the free space exchange rate (FA) was calculated to a value of 30.14, thus giving a rinsing number (SZ) of 1.828.

The shut-off member was verified as suitable for the particular use, this is confirmed by the characteristics determined.

### Example 9

### FIG. 12

A ball valve according to Example 8 where the closure element was provided without an inlet-side recess and without rinsing holes. The closure element (the ball) was turned down transversely to the direction of flow in a cylindrical shape to a smaller diameter in order to ensure easier flow through the free space.

The ball valve had a nominal diameter of 63 mm, the housing inside diameter (D_{G}) was 102 mm, the diameter of the closure element transverse to the direction of passage (D_{V}) was 72 mm (cylindrical).

The free space volume (Fₜₒₜ) through which flow took place was 329 cm³. A product flow (V_{P}) of 5.74 dm³/min was passed therethrough. At a nominal flow rate (v_{N}) of 1.84 m/min, this yielded a pressure loss (p) of about 0.5 bar.

1. A shut-off member which comprises: a valve housing having an interior and at least one inlet and at least one outlet and a closure element, which is mounted rotatably about an axis in the interior, wherein between the closure element and the valve housing there is a free space for flow of a fluid between inlet and outlet and a pair of sealing surfaces is provided at the at least one inlet between valve housing and closure element, wherein the sealing surface of the closure element is pivotable through rotation of the closure element and in the locking position of the shut-off member shuts off the inlet by fluid-tight bearing against the sealing surface of the valve housing, the distance of the sealing surfaces from the axis or the centre point of the closure element is greater than the distance of the axis or the centre point to other outer regions of the closure element in order to form the free space which in the locking position is connected to the outlet in a fluid-conducting manner and/or
that the distance of the sealing surfaces from the axis or the centre point of the closure element is shorter than the distance of the axis or the centre point to other regions of the valve housing interior in order to form the free space which in the locking position is connected to the outlet in a fluid-conducting manner.

2. The shut-off member according to claim 1, characterised in that the closure element and/or the interior of the valve housing are designed in such a manner that in an open position
the differential pressure between inlet and outlet formed by the shut-off member is at least 0.4 bar;
the rinsing flow ratio formed by the free space flow divided by the total fluid flow is at least 0.1%;
the nominal gap speed formed by the free space flow divided by free space cross-section is at least 0.1 m/min; and/or
the free space exchange rate formed by the free space flow divided by the free space volume is at least 1 l/min.

3. The shut-off member according to claim 1, characterised in that the cross-section of the free space between the valve housing and the closure element in a partial and/or complete opening position of the shut-off member is matched to the viscosity of the fluid and is at least sufficiently large that a rinsing flow is achieved in the free space on both sides of the axis.

4. The shut-off member according to claim 1, characterised in that the closure element is adapted for periodic rinsing of the free space 69-behind the pair of sealing surfaces.

5. The shut-off member according to claim 1, characterised in that the axis of the closure element is disposed at the centre point of the closure element.

6. The shut-off member according to claim 1, characterised in that the closure element is partially spherical and/or has a spherical segment-shaped shut-off part with the sealing surface.

7. The shut-off member according to claim 1, characterised in that the sealing surface of the valve housing and/or the closure element is disposed on a sealing projection and/or when viewed inside the sealing surface of the closure element a recess is provided on the outer area.

8. The shut-off member according to claim 1, characterised in that the sealing surface of the valve housing and/or of the closure element, in particular on a sealing projection, is circular in view.

9. The shut-off member according to claim 1, characterised in that the sealing surfaces are disposed at the inlet and the outlet is free from any sealing element.

10. The shut-off member according to claim 1, characterised in that the free space is formed by a recess, in particular a recess delimited by the sealing surface or the sealing projection, wherein the valve housing has the recess towards the interior and/or the closure element towards the valve housing.

11. The shut-off member according to claim 1, characterised in that the interior space is partially spherical or cylindrical.

12. The shut-off member according to claim 1, characterised in that the closure element has a hole for flow of a fluid between inlet and outlet in the opening position of the device, wherein
preferably further connecting holes connect the hole to the free space in a fluid-conducting manner.

13. The shut-off member according to claim 12, wherein the hole before the outlet has a constriction and/or a flow resistance element, preferably a perforated plate.

14. The shut-off member according to claim 1, characterised in that the closure element is a solid body without flow hole normal to the axis.

15. The shut-off member according to claim 1, characterised in that the valve housing and/or the closure element consist of a metal or a metal alloy, wherein it is preferably iron-containing.

16. Use of a shut-off member according to claim 1 for controlling the flow of a fluid, wherein in an open position or free-space rinsing position of the closure element
the differential pressure between inlet and outlet formed by the shut-off member is at least 0.4 bar;
the rinsing flow ratio formed by the free space flow divided by the flow through the hole is at least 0.1%;
the nominal gap speed formed by the free space flow divided by free space cross-section is at least 0.1 m/min; and/or
the free space exchange rate formed by the free space flow divided by the free space volume is at least 1 l/min.

17. Use of a shut-off member according to claim 1 in a line during the transport of chemically unstable fluids, wherein the chemically unstable fluid is preferably explosion-prone upon deposition in the shut-off member.

18. Use of a shut-off member according to claim 16, characterised in that the fluid is a moulding compound, preferably a spinning compound and/or wherein the fluid is a cellulose solution, preferably a solution of cellulose with an amine oxide, particularly preferably with NMMO.

19. A method for producing moulded bodies from a fluid moulding compound comprising: transporting a fluid moulding compound through a line having a shut-off member according to claim 1 or using a shut-off member according to claim 16, wherein the line leads via the outlet of the shut-off member to a moulding unit, in particular an extruder, having openings through which the moulding compound is pressed and thereby moulded, and hardening the moulding compound, preferably by solidification or coagulation.
